(19) United States
(12) Patent Application Publication
(10) Pub. No.: US 2024/0400347 A1
(43) Pub. Date: Dec. 5, 2024

(54) DRILL TRAIL CABLE MANAGEMENT SYSTEM

(71) Applicant: FLANDERS ELECTRIC MOTOR SERVICE, LLC, Evansville, IN (US)

(72) Inventors: John Robert OLIVER, Newburgh, IN (US); Graeme Coll FINDLAY, Brisbane (AU); Gustavo Lazatin SUMCAD, League City, TX (US)

(73) Assignee: FLANDERS ELECTRIC MOTOR SERVICE, LLC, Evansville, IN (US)

(21) Appl. No.: 18/735,156

(22) Filed: Jun. 5, 2024

Related U.S. Application Data
(60) Provisional application No. 63/471,233, filed on Jun. 5, 2023.

(51) Int. Cl. B65H 75/44; B65H 75/42; E21B 7/02

(52) U.S. Cl. CPC B65H 75/4402; B65H 75/425; E21B 7/02; B65H 2701/34

(57) ABSTRACT

A device including a platform and a drill connected to the platform. The device also includes a power source for powering the drill. The device also includes a cable connected to a cable reel and to the drill. The device also includes a stinger having a first end connected to the platform and a second end opposite the first end. The stinger includes a beam extending outwardly from the platform. The second end of the stinger connects to the cable. The stinger is configured to guide a position of the cable, relative to the platform, as the cable moves relative to the platform and relative to the stinger.

### CROSS-REFERENCE TO RELATED APPLICATIONS

This application claims priority to U.S. Provisional Patent Application Ser. No. 63/471,233, filed Jun. 5, 2023, the entirety of which is hereby incorporated by reference.

### BACKGROUND

Blast hole drilling creates chips of earth and stone that pile up in a cone around a drill hole. The cone of chips is referred to as a chip pile.

In some scenarios, a drill trail cable behind the drill moves in a position where the drill trail cable drags across one or more chip piles. (There may be more than one drill hole having chip piles, and so the drill trail cable may drag across multiple chip piles). When the drill trail cable drags across one or more chip piles, the chips in the chip piles may be urged back into one or more drill holes. It is undesirable for the chips to fall back into a drill hole.

Thus, when chips begin to fall back into a drill hole, drilling stops. A cable crew manually repositions the drill trail cable away from the chip piles before drilling continues. Some mine operators may choose to remove the cable reel completely from the drill if the cable reel does not operate as desired.

### SUMMARY

One or more embodiments provide for a device. The device includes a platform and a drill connected to the platform. The device also includes a power source for powering the drill. The device also includes a cable connected to a cable reel and to the drill. The device also includes a stinger having a first end connected to the platform and a second end opposite the first end. The stinger includes a beam extending outwardly from the platform. The second end of the stinger connects to the cable. The stinger is configured to guide a position of the cable, relative to the platform, as the cable moves relative to the platform and relative to the stinger.

One or more embodiments provide for a method. The method includes winding or unwinding a cable from a cable reel connected to a platform. The method also includes guiding the cable along a stinger that is connected to the platform. The method also includes moving the stinger to adjust a position of the cable along the ground. The position is disposed away from the platform.

One or more embodiments provide for another device. The device includes a platform and a drill connected to the platform. The device also includes a power source for powering the drill. The device also includes a cable connected to a cable reel and to the drill, and/or the device may include a stinger having a first end connected to the platform and a second end opposite the first end. The stinger includes a beam extending outwardly from the platform. The second end of the stinger connects to the cable. The stinger is configured to guide a position of the cable, relative to the platform, as the cable moves relative to the platform and relative to the stinger. The stinger has a length sufficient to force the cable to move outside of an outer radius of a chip pile formed around a drill hole drilled by the drill. The stinger further includes an end effector directly connected to the second end of the stinger. The end effector is configured to permit the cable to slide with respect to the end effector as the stinger pushes the cable. The device also includes a drum connected to the platform and to the first end of the stinger. The drum is configured to move the stinger relative to the platform. The device also includes an actuator disposed within the drum and configured to move stinger. The device also includes a propulsion system connected to the platform and configured to move the platform as the cable reel dispenses the cable.

Other aspects of the one or more embodiments will be apparent from the following description and the appended claims.

### BRIEF DESCRIPTION OF DRAWINGS

FIG. 1 shows a drilling environment, in accordance with one or more embodiments.

FIG. 2 and FIG. 3 show drilling machines, in accordance with one or more embodiments.

FIG. 4, FIG. 5, and FIG. 6 show drilling machines having drill trail cable management systems, in accordance with one or more embodiments.

FIG. 7, FIG. 8, FIG. 9, and FIG. 10 show different actuators that may be used with respect to the stinger shown in FIG. 4 through FIG. 6, in accordance with one or more embodiments.

FIG. 11 shows a method, in accordance with one or more embodiments.

Like elements in the various figures are denoted by like reference numerals for consistency.

### DETAILED DESCRIPTION

In general, embodiments are directed to a drill trail cable management system. A stinger, configured to move at various angles with respect to a drilling machine attached to the stinger, is used to guide the drill trail cable. In this manner, the drill trail cable may be guided away from chip piles. Thus, the one or more embodiments address the issue of time wasted while a drill trail cable is manually repositioned to prevent chip ingress into a drill hole.

Cable management according to one or more embodiments described herein may have multiple benefits, as mines are increasing the use of electrified equipment on the bench (a working site) while increasing decarbonization efforts. Handling of cables historically was via cable reels, which were prone to failure and damage. Furthermore, cable management has been complicated by modern safety rules because manual manipulation of energized cables is often banned by regulatory authorities. Thus, the process of safe cable manipulation may involve a multi-stage read back confirmation process to ensure the proper isolation of equipment. The process can often add 40-60 minutes to a cable or machine electrical isolation procedure. The resulting delays are multiplied when multiple cables are to be moved or otherwise handled at a bench. Accordingly, the delays may be significant, leading to significant impact on increased costs and project delays. Additionally, one or more embodiments may help prevent potential damage to misplaced cables that are run over, that often times produce shorts, and consequently, significant downtime in isolation, replacement of cable, and other associated costs.

The issues are further complicated because many mines are taking on new electrical equipment, drills and excavators that had been traditionally diesel. Thus, cable management becomes increasingly important to mine operators. Yet further many mine operators, used to diesel powered equipment, may not have experience in cable management.

One or more embodiments address these and other issues by providing a cable management system. Again, as mentioned above and as described further below, a stinger is used to move a cable into a desired location.

For clarity, the term “cable,” when used herein, refers to a “drill trail cable.” Thus, the term “cable” may include the features common to drill trail cables used in the mining industry. Nevertheless, one or more embodiments described herein also may be applicable to managing the position of other cables, ropes, lines, etc.

In addition, various embodiments described below discuss positioning a cable being used to power drilling equipment (e.g., a drilling platform, a trailer, etc.). However, the stinger of one or more embodiments also may be attached to other types of equipment for which cable management is deemed useful. For example, the stinger of one or more embodiments may be connected to trucks, shovels, trains, or other equipment that use cables for power or control during mining operations. In another example, the stinger of one or more embodiments may be used to control the position of connecting lines of other types (e.g., a rope bridge). Thus, one or more embodiments are not limited to drilling equipment or to mining applications.

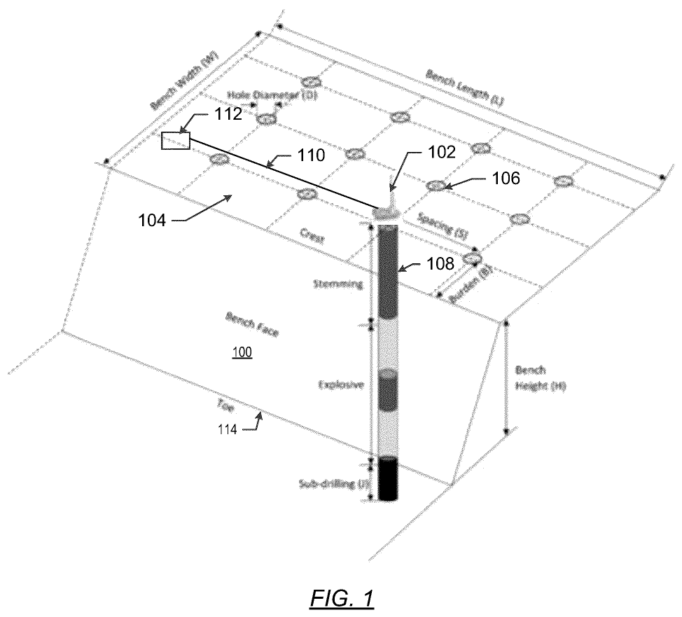

FIG. 1 shows a drilling environment, in accordance with one or more embodiments. In particular, FIG. 1 shows a bench (100) where a drill (102) operates at the crest (104) of the bench (100). The bench (100) is the slope in front of a previously excavated area of land. A drill (102) drills one or more holes at the crest (104), such as hole (106) or hole (108).

A cable (110) may extend from the drill (102) to a power source (112). The cable (110) may provide power to the drill (102) or other equipment operating on a platform upon which the drill (102) is mounted.

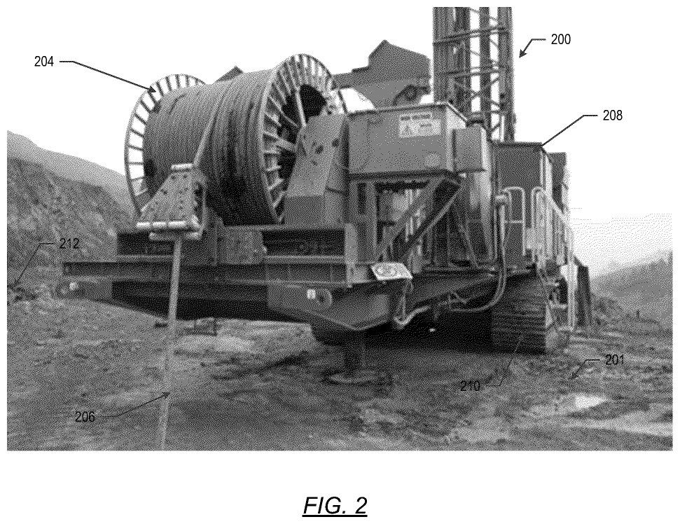

A cable reel (see FIG. 2), mounted to the rear of the platform on which the drill (102) is mounted, reels in the cable (110) as the platform moves. Most of the time, the cable reel is bringing in the cable as the drill (102) moves towards the power source (112). However, the cable reel may also let out cable as the drill (102) moves away from the power source (112).

The cable reel plays a useful part in the management of the cable as the drill moves along the bench. An automatic controller may reel in and pay out the cable when desired.

The other end of the trail cable is attached to a switch house or disconnect. The disconnect could be located on or above the bench (100) where the drill (102) is operating. Cable sections may be added to extend the length of the cable (110). The cable (110) may be coiled up at the toe (114) of a bench face. The toe (114) is the bottom of the bench (100).

The cable reel in the one or more embodiments may be driven by an electric motor. The electric motor may be controlled by a variable speed drive system. The electric motor may control the cable reel rotation direction (reel in or payout direction), at a rotational speed consistent with a tramming speed of the drill rig. The electric motor also may control or maintain tension on the cable (110). The controls for the motor may be controlled by an algorithm that takes into account the global position of the platform on which the drill (102) is mounted, or a position of a cable reel trailer or cable reel buggy.

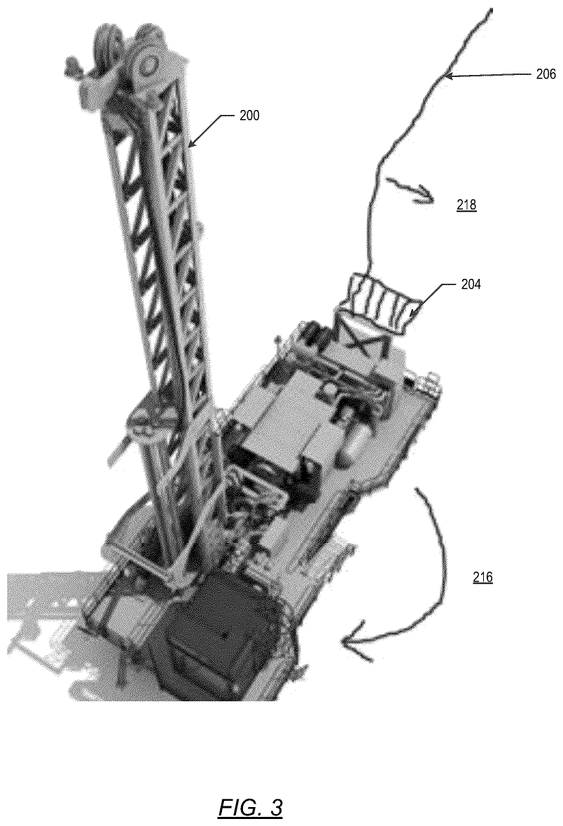

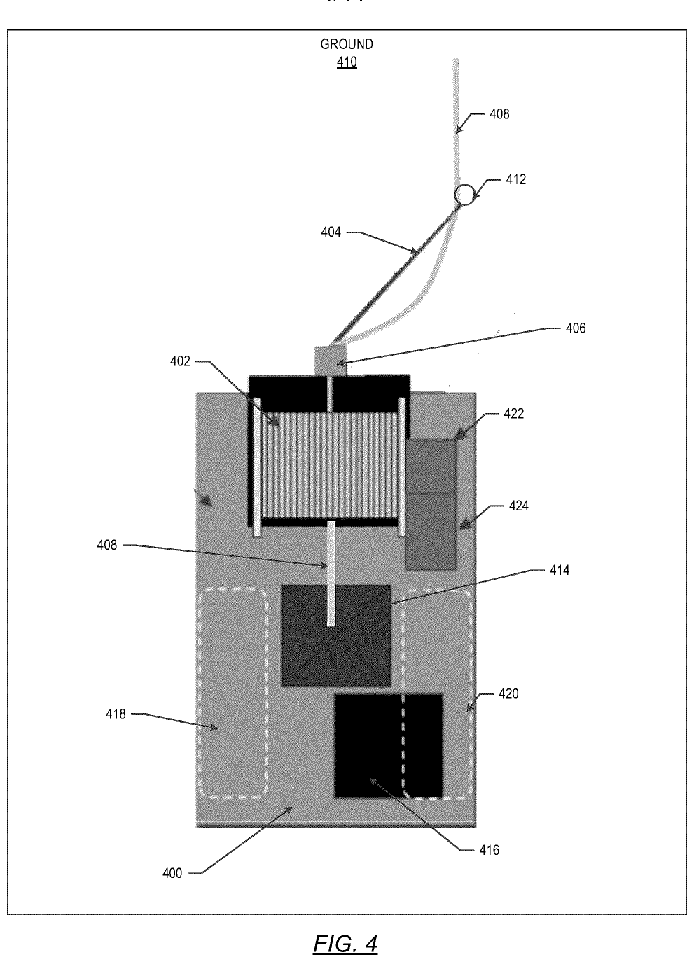

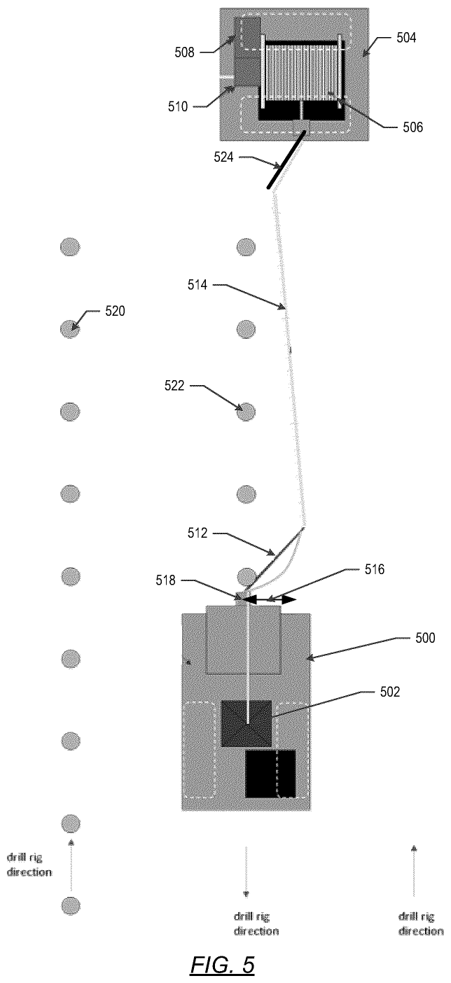

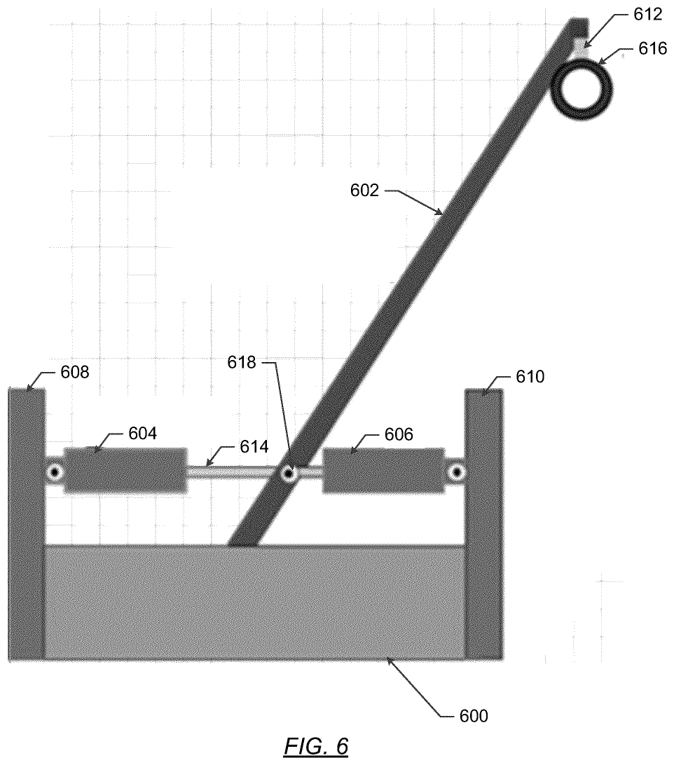

FIG. 2 and FIG. 3 show drilling machines, in accordance with one or more embodiments. In both FIG. 2 and FIG. 3 the drill (200) may drill a hole in the ground (201). A cable reel (204) may take up slack, or let out cable (206), as the platform (208) that mounts the drill (200) moves via a propulsion system (210) over the ground (201). The propulsion system (210) in FIG. 2 includes treads that move along the ground (201) and an engine and drive train that provides power to the treads. Thus, the propulsion system (210) is connected to the platform (208) and is configured to move the platform (208) as the cable reel (204) dispenses the cable (206).

The drill (200), the cable reel (204), and the cable (206) are connected to the platform (208), as shown. However, other arrangements are possible, as shown in FIG. 5. The platform shown in FIG. 2 and FIG. 3 may be a vehicle, but also may be a stable structure connected to the ground.

Drilling the hole in the earth (e.g., the hole (108) in FIG. 1) moves material from the hole onto the ground. While the material formerly in the hole may be hauled off during the drilling operation, a chip pile (212) may form around the hole. The chip pile (212) is chips, clumps, or pieces of earth, rock, sediment, etc. removed from the ground as the drill (200) digs the hole in the ground. The chip pile (212) may have a roughly toroidal shape, where the hole is in the center of the toroid. The chip pile (212) may have a peak height and an average outer diameter. The outer diameter is where the chip pile (212) is deemed to end, though stray chips dug from the hole may extend well outside of the outer diameter boundary.

It is theorized that the issue of dragging the cable (206) into one or more chip piles (e.g., the chip pile (212)) is due to a disconnect between the position of the cable (206) on the ground near the drill (200), the cable reel (204) automation, and the subsequent turning of the drill (200). There can be times when the cable reel (204) does not pay out the cable (206) when more cable is needed. As a result, tension increases in the cable (206), thereby dragging the cable (206) on the ground and into chip piles.

This effect could occur in arrangements like those shown in FIG. 3, in which the platform on which the drill (200) is mounted is shown to turn clockwise, as indicated by arrows (216). As a result, the cable (206) trails to the left, opposite the direction shown by arrow (218), and the cable reel (204) does not pay out additional cable. The result of turning the platform therefore may be a tightening of the cable (206) and dragging of the cable (206) toward the right, as indicated by arrow (218), where previous holes could be located.

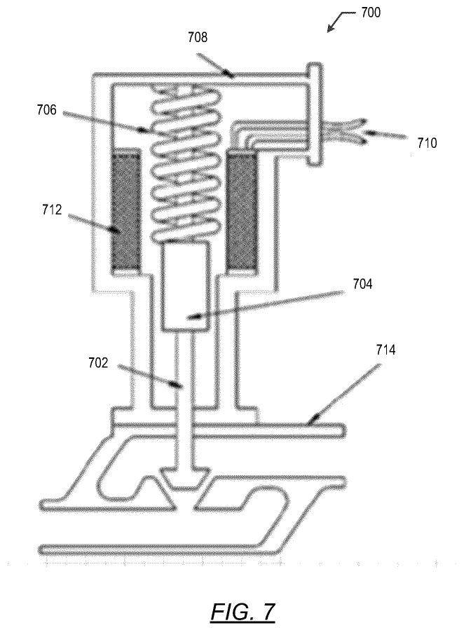

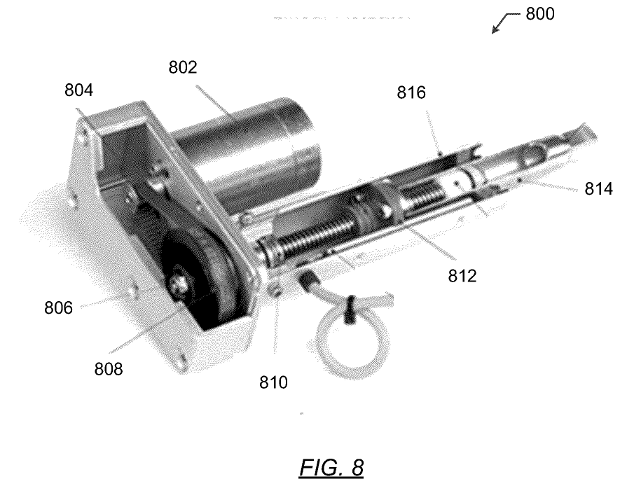

FIG. 4 through FIG. 6 show drilling machines having drill trail cable management systems, in accordance with one or more embodiments. FIG. 4 shows a variation the platform (400) that includes a mounted cable reel (402).

As shown, a stinger (404) extends outwardly from the platform (400) or the cable reel (402). The stinger (404), at a first end, may be supported by one or more drums, such as drum (406). The stinger (404), at a second end, supports a cable (408) as the cable (408) exits the cable reel (402) before the cable (408) lowers to the ground (410). The second end of the stinger (404) is disposed in a sliding relationship to the cable (408). In other words, the cable (408) may slide along, through, around, over, etc., while touching the second end of the stinger (404). However, an end effector, described further below, disposed at the second end of the stinger (404) may satisfy the description of the cable (408) being in a sliding relationship with the stinger (404).

The stinger (404) may be automated, with actuators on each side, allowing the stinger (404) to move left or right based on the location of the cable (408) on the ground (410). The actuators could be tied into the drill track controls to swing the stinger (404) horizontally, relative to a direction of gravity, based on drill turning. In FIG. 4, the direction of gravity faces directly into the page showing FIG. 4. An end effector (412) may be placed at the end of the stinger (404) to manage movement of the cable (408) during use.

The stinger (404) may be characterized as a beam or an arm. The beam or arm may have a number of different cross sectional shapes, such as a rectangle, square, u-shape, triangle, or some complex polygon.

Thus, the stinger (404) may be described as being configured to guide a position of the cable (408), relative to the platform (400), as the cable (408) moves relative to the platform (400) and relative to the stinger (404). In this manner, the cable (408) may move the cable (408) such that the cable (408) avoids chip piles that may surround drill holes in the ground.

As previously stated, there may be a disconnect between the reel sensing to pay out or in based on drill movement, and location of the cable on the ground. However, additional sensors may be placed on the platform (400) to relate the cable movement with the cable reel, and also to relate the cable placement on the ground outside of the platform (400).

The platform (400) may include a number of additional features. For example, the platform (400) may include a drill (414) mounted to the platform (400). The platform (400) may include a power source (416) that is used to power various systems on the platform (400). The power source (416) may be in addition to power provided via the cable (408).

The platform (400) may include a propulsion system. The propulsion system may include the power source (416), and one or more wheels or treads, such as left tread (418) and right tread (420).

The platform (400) also may include a motor (422). The motor (422) may drive the cable reel (402). Power for the motor (422) may come from the power source (416) or from the cable (408).

The platform (400) also may include one or more drive controls (424). The drive controls (424) may be used to control various aspects of the platform (400), including moving the platform (400), operating the drill (414), or operating other functions of the platform (400).

For example, the drive controls (424) may be used to control the motor (422) to increase or decrease either the cable tension or the rate of cable outlay or take-up. Sensors may sense a position, tension, and speed of cable outlay or take-up. An algorithm, executed by the drive controls (424), may be used to process data taken by the sensors. The data may include, for example, global positioning system (GPS) data, connected to the platform (400) or to a trailer (see FIG. 5) that may be used to determine a rate of outlay or take-up of the cable (408). The data may include a tension in the cable (408). The data may include a speed of rotation of the cable reel (402). The data may include a measured position of the cable (408) with respect to the platform (400), with respect to a trailer (see FIG. 5), or with respect to a coordinate system defined with respect to the bench or other working site where the platform (400) is being used.

The output of the algorithm may be automatic adjustments to the cable tension or rate of cable outlay or take-up, which are in turn applied by the drive controls (424). The adjustments may further adjust the position of the cable (408). In an embodiment, the drive controls (424) alone may influence positioning of the cable (408), such as when the stinger (404) is not present or not functioning for whatever reason.

In another embodiment, the cable reel (402) may be disposed on a turntable or connected to equipment that may change an orientation of the cable reel (402) with respect to the platform (400). In this case, the algorithm and the drive controls (424) may be used to control the position of the cable reel (402) with respect to the platform (400) in order to influence, or further influence, the position of the cable (408) with respect to the platform (400). The use of a turntable to control the orientation of the cable reel (402) may be used alone, or in combination with the stinger (404) or other controls, when influencing the position of the cable (408) with respect to the platform (400).

The drive controls (424) also may be used to synchronize commands issued to autonomous vehicles or mining equipment. For example, the drive controls (424) may change the speed of a haul truck in response to a change of outlaw or take-up of the cable (408), whether or not the haul truck is connected to the cable (408). For example, if the drive controls (424) slows the outlay or take-up of the cable (408), then the drive controls (424) may command an autonomous haul truck to slow down in order to accommodate a slower rate of chip production that results when the rate of outlay or take-up of the cable (408) is slowed. Still other variations are possible.

FIG. 5 shows a variation of the platform (400) shown in FIG. 4. In FIG. 5, the platform (500) to which a drill (502) is mounted is separate from a trailer (504) on which the cable reel (506) is mounted. In the arrangement of FIG. 5, the drive controls (508) and the motor (510) may be located on the trailer (504).

However, the stinger (512) is located on the platform (500). In this case, the stinger (512) may move to one side an additional distance, relative to the variation in FIG. 4, the closer the current hole is to the trailer (504).

Thus, it may be said that a trailer (504) is connected to the platform (500) via a cable (514). The cable reel (506) is disposed on the trailer (504). The trailer (504) is horizontally offset from the platform (500), relative to a direction of gravity, by an offset distance indicated by arrows (516). Again, the direction of gravity is into the page on which FIG. 5 is shown. Thus “horizontally” may be from left to right, as shown in FIG. 5. However, if the trailer (504) were moved to another side of the platform (500), then “horizontally” may be up and down relative to the page on which FIG. 5 is shown (i.e., along a direction perpendicular to the arrows (516)).

The stinger (512) may have a length sufficient to guide the cable (514) horizontally away from the platform (500), relative to the direction of gravity, according to the offset distance indicated by the arrows (516). The term “sufficient” corresponds to an engineering tolerance set by an engineer or some automated process.

The stinger (512) also may be characterized as having a length sufficient to force the cable (514) to move outside of an outer radius of a chip pile formed around a drill hole drilled by the drill. Again, the term “sufficient” corresponds to an engineering tolerance. Forcing the cable to move outside of the outer radius may take into account movement of the platform (500) or the stinger (512), or both. Thus, the term “having a length sufficient to force the cable (514) to move outside the outer radius of a chip pile”—or to move the cable (514) any other distance-means that the length of the stinger is sufficient, when possibly combined with movement of the platform (500), pushes the cable (514) away from the chip pile. In any case, the stinger (512) may be configured to push the cable (514) away from one or more drill holes (e.g., hole (520)) where chip piles are likely to accumulate as a result of drilling into the ground.

A drum (518) may be connected to the platform (500) and to the first end of the stinger (512). The first end of the stinger is the end of the stinger attached to the platform (500), whether via the drum (518) or via some other device. The drum (518) may be configured to move the stinger (512) relative to the platform (500). Thus, the drum (518) is connected to the platform (500) and to the first end of the stinger (512) and the drum (518) is configured to move the stinger (512) relative to the platform (500). The drum (518) may be configured to move the stinger (512) independently of movement of the platform (500).

The stinger (512) may move not only horizontally, as described above, but in some embodiments also may move vertically relative to the direction of gravity (i.e., into or out of the page on which FIG. 5 is shown). Accordingly, the stinger (512) may be configured to move, independently of movement of the platform (500), in a direction including at least one of horizontally and vertically relative to a direction of gravity (the direction of gravity being into the page showing FIG. 5).

In use, when the drill (502) reaches the bottom of a hole, the platform (500) turns and moves to the next column of prior-drilled holes. Thus, the platform (500) may move from the column of holes that includes hole (520) to the column of holes that includes hole (522). The platform (500) still faces the same direction, but now starts moving in reverse towards the trailer (504). When the platform (500) is moving, the stinger (512) also moves to prevent the cable (514) from dragging over chip piles surrounding the drill holes.

Additionally, the trailer (504) may move to the right or left, relative to the platform (500), to synchronize with the movement of the platform (500). In this manner, the offset distance represented by arrows (516) may remain constant, or within a range of acceptable offset distances.

The movement of the trailer (504) may also cause a control system to control movement of the stinger (512) to prevent the cable (514) from intersecting chip piles. The control system may be located on the platform (500), the trailer (504), or may be located remotely. Nevertheless, the control system interacts with the actuators connected to the stinger (512) in order to control the position of the stinger (512).

The motor (510) may be used to control tensioning of cable on the cable reel (506), in addition the rolling and unrolling functions. A global positioning system (GPS) receiver may be used to determine a true position of the drill (502), platform (500), cable reel (506), trailer (504), and a home position of either or both of the platform (500) and the trailer (504).

Other variations are possible. For example, the cable reel (506) may be mounted on a turntable base to provide 360-degree positioning capability. Thus, both the cable reel (506) and the stinger (512) may be moved, possibly in tandem, to change the position of the cable (514) on the ground in order to avoid the cable (514) from dragging over chip piles surrounding the drill holes.

In still another variation, a second stinger (524) may be located on the trailer (504). The second stinger (524) may be structured and controlled as described above with respect to FIG. 1 through FIG. 4, and the above description with respect to FIG. 5. The second stinger (524) therefore may be used to provide impose further control on the position of the cable (514). The second 63948732v4 stinger (524) may be useful for further controlling the position of the cable (514) when the terrain is rough or when other factors may influence the position of the cable (514), and the use of a single stinger (i.e., the stinger (512)) is deemed insufficient to control the position of the cable (514), for whatever reason.

In yet another variation, the second stinger (524) may instead be the one stinger that is used to control the position of the cable (514). In other words, the stinger (512) is not attached to the platform and is not present. Rather, the second stinger (524), attached to the trailer (504), is used to control the position of the cable (514) in a manner similar to that described above with respect to the stinger (512) (substituting the trailer (504) for the platform (500) in the description above).

Still other variations are possible. For example, multiple stingers may be present on the platform (500), the trailer (504), or both. For example, in an embodiment, the trailer (504) may include two stingers and the platform (500) may include two stingers. When multiple stingers are used, the stingers may be of different lengths or may include different end effectors for managing the position of the cable (514). In an embodiment, multiple end effectors could be used to raise the position of the (514) entirely off the ground so that the cable (514), rather than dragging on the ground, instead is held above the ground. Still other variations are possible.

FIG. 6 shows additional details regarding the stinger (404) shown in FIG. 4 and the stinger (512) shown in FIG. 5. The platform (600) is shown for reference.

In particular, FIG. 6 shows the stinger (602) and the actuators (e.g., actuator (604) and actuator (606)) that control one or more positions of the stinger (602), as well as an end effector (616) at an end of the stinger (602).

The stinger (404) may be controlled by one or more hydraulic cylinders (see FIG. 6). In the case of two hydraulic cylinders (e.g., actuator (604) and actuator (606)), one hydraulic cylinder may be located to the left and one hydraulic cylinder may be located to the right of the stinger near one or more anchors (e.g., anchor (608) and anchor (610)). In an embodiment, the anchor (608) and the anchor (610) together may be part of the drum described with respect to FIG. 2 through FIG. 5.

The hydraulic cylinders may move along a crosspiece (614). The crosspiece (614) is a rod, beam, plank, etc. and may be retractable or telescopic along a length of the crosspiece (614). Thus, the actuator (604) and the actuator (606) may push or pull on the crosspiece (614) in order force the crosspiece (614) to move.

A rotatable joint (618) may be operably connected to the crosspiece (614) and to the stinger (602) such that actuation of an actuator extends or retracts the crosspiece (614) and extension or retraction of the crosspiece (614) causes the stinger (602) to move relative to the anchor (608) or the anchor (610). Specifically, the rotatable joint (618) rotates as the crosspiece (614) pushes the stinger (602) back and forth under the urging of one or both of the actuators.

The hydraulic cylinders may be replaced with different types of actuators, such as electric actuators, solenoid actuators, linear actuators, gear actuators, etc. In any case, if one actuator pulls, the other actuator pushes to move the stinger (602) to one side or the other. The position of the stinger (602) may be controlled by controls located on the drill vehicle or remotely. The cable (612) may move outside the stinger (602), or in some cases the stinger (602) may be hollow and the drill trail cable moves within the stinger (602).

The end effector (616) is a device connected to a second end of the stinger (602). The second end of the stinger (602) is the end opposite the first end of the (602) (the first end of the stinger (602) is connected to the platform (600)). The end effector (616) is configured to permit the cable (612) to slide with respect to the end effector (616) as the stinger (602) pushes the cable (612). The end effector (616) also may aid in guiding the cable (612) as the cable (612) slides with respect to the stinger (602).

The end effector (616) in FIG. 6 is a cable loop. The cable loop may control movement of the cable, and also may reduce friction between the cable (612) and the stinger (602) as the cable (612) moves distally and proximally with respect to the stinger (602).

The end effector (616) may take different forms. For example, the end effector (616) may be a pulley, a second cable reel, a cable guide, a u-shaped trough in which the cable (612) is disposed, or many other shapes and devices. The end effector (616) may be directly connected to the second end of the stinger (602), or may be connected to the stinger (602) via an indirect means (e.g., with an intervening device between the stinger (602) and the end effector (616)). The end effector (616) may be connected to the stinger (602) at other locations along a length of the stinger (602).

As shown in FIG. 6, the stinger (602) may be located along an outside axis of the cable reel. The stinger (602) may include a cable handler, positioner structure, or end effector at one end of the arm or beam that forms the stinger (602). For example, the cable handler, positioner structure, or end effector may be a low-resistance eye loop, or may be a pulley, or curved friction plate.

The stinger (602) also may have the capability to be positioned left of right (or axially up or down) of the cable reel. The described movement capability may be provided by mechanical or electrical actuators to position the arm left or right of the axis of holes being drilled.

In an embodiment, the stinger (602) may be spring-loaded to an opposite position so that the stinger (602) is urged back into a pre-determined angle when not under a pre-determined tension imposed by the cable (612) or by an actuator. Additional actuators may be deployed.

An example of a device contemplated by one or more embodiments is now presented in view of FIG. 2 through FIG. 6. The device includes platform and a drill connected to the platform. The device also includes a power source for powering the drill. The device also includes a cable connected to a cable reel and to the drill. The device also includes a stinger having a first end connected to the platform and a second end opposite the first end. The stinger may be a beam extending outwardly from the platform. The second end of the stinger connects to the cable. The stinger is configured to guide the cable to a position relative to the platform, as the cable moves relative to the platform and relative to the stinger. The stinger has a length sufficient to force the cable to move outside of an outer radius of a chip pile formed around a drill hole drilled by the drill. The stinger further includes an end effector directly connected to the second end of the stinger. The end effector is configured to permit the cable to slide with respect to the end effector as the stinger pushes the cable. The device also includes a drum connected to the platform and to the first end of the stinger. The drum is configured to move the stinger relative to the platform. The device also includes an actuator disposed within the drum and configured to move the stinger. The device also includes a propulsion system connected to the platform and configured to move the platform as the cable reel dispenses the cable.

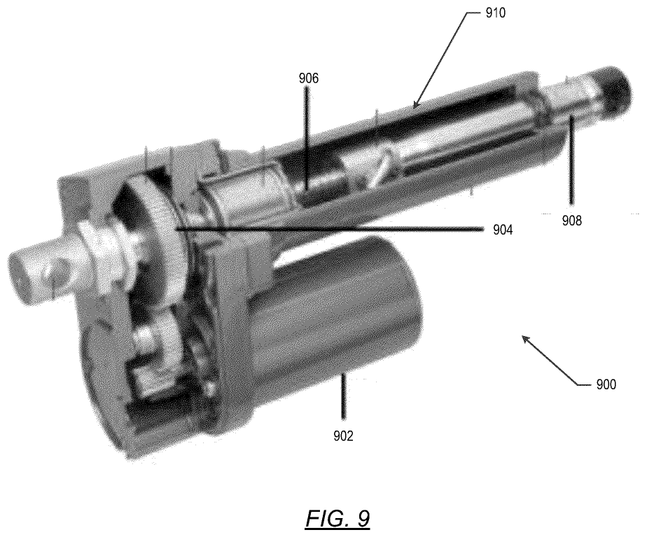

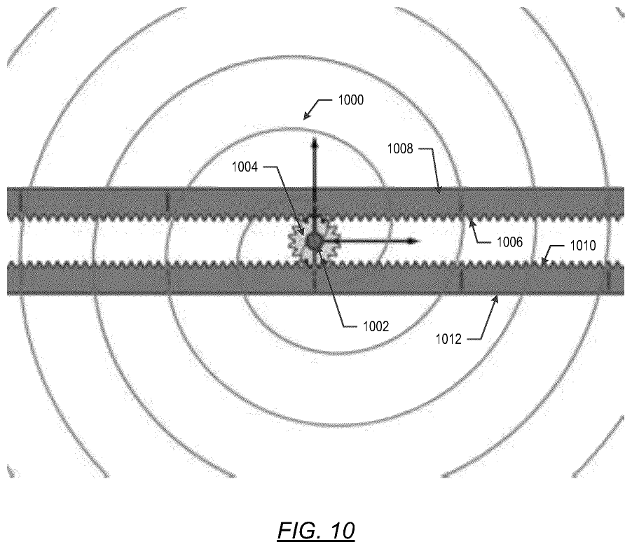

FIG. 7, FIG. 8, and FIG. 9 show different actuators that may be used with respect to the stinger shown in FIG. 4 through FIG. 6, in accordance with one or more embodiments. FIG. 7 shows a solenoid actuator. FIG. 8 shows a linear actuator. FIG. 9 shows a rotary actuator. FIG. 10 shows a rack and pinion mechanism driven by a motor.

FIG. 7 shows a solenoid actuator (700). The solenoid actuator (700) includes a stem (702) connected to an armature (704). A spring (706) is connected to the armature (704). The stem (702) moves in and out of a housing (708) in response to a motive force applied to the armature (704) when an electrical current is passed from an electrical connection (710) to a coil (712). A control valve (714) may further control motion of the stem (702).

FIG. 8 shows a linear actuator (800). A motor (802) drives a drive belt (804) about an adjustable slip clutch (806) via a pulley (808). Rotation of the adjustable slip clutch (806) rotates a drive screw (810) relative to an anti-rotation collar (812), which in turn forces a shaft (814) to move inwardly and outwardly relative to a housing (816) of the linear actuator (800).

FIG. 9 shows another linear actuator (900). A motor (902) drives a gear system (904). The gear system (904) in turn drives a drive screw (906). The drive screw forces an extension tube (908) to move inwardly and outwardly relative to a housing (910) of the linear actuator (900).

FIG. 10 shows another linear actuator (1000), and specifically a rack and pinion actuator. A motor (not shown) rotates a drive shaft (1002). Rotation of the drive shaft (1002) turns a gear (1004). The gear (1004) engages upper teeth (1006) in an upper housing (1008) and lower teeth (1010) in a lower housing (1012). If the gear (1004) is fixed in position, then the upper housing (1008) and the lower housing (1012) will move back and forth, depending on the direction of rotation of the gear (1004).

The linear actuators of FIG. 7 through FIG. 10 may be push-pull solenoids, pneumatic and hydraulic cylinders, or an electric motor (AC or DC) driving a gear and a screw. Rotary actuators may rotate as desired to position the stinger left or right and may rotate by various angles. Example angles of rotation may be 45 degrees, 90 degrees, 180 degrees, or more.

The one or more actuators may be driven using an algorithm that takes into account global position of the platform, the drill, the cable reel, the trailer, or other equipment with respect to an axis of the drilled holes (pattern), and the platform's tramming direction backwards or forwards. By controlling the actuators, the algorithm may control the placement of the stinger and hence the placement of the cable on the ground.

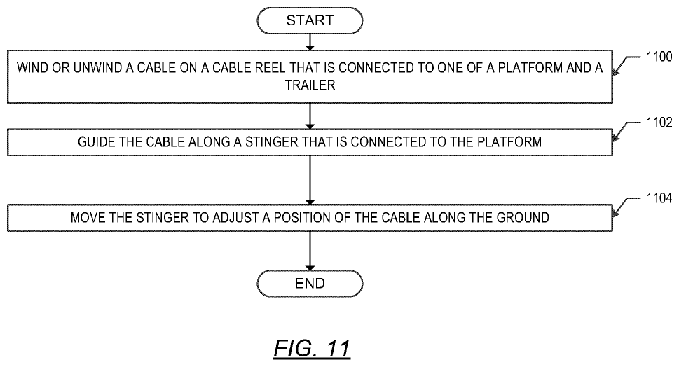

FIG. 11 shows a method, in accordance with one or more embodiments. The method of FIG. 11 may be executed using the devices shown in FIG. 2 through FIG. 6.

Step 1100 includes winding or unwinding a cable on a cable reel that is connected to one of a platform and a trailer. For example, a motor attached to the cable wheel may take in or let out cable from the cable reel.

Step 1102 includes guiding the cable along a stinger that is connected to the platform. Guiding the cable along the stinger may be performed by threading the cable through an end effector at a second end of the stinger, where the first end of the stinger is connected to the platform. Guiding the cable also may include allowing the cable to move along a groove at the second end of the stinger, or a groove disposed along a length of the stinger. Guiding the cable may include sliding the cable along, within, or over the second end of the stinger.

Step 1104 includes moving the stinger to adjust the position of the cable along the ground. The position is disposed along a direction away from the platform. Thus, the cable may be prevented from moving over or through chip piles as a result of the cable position having been adjusted. When the cable reel is connected to the platform, the stinger adjusts the position of the cable as the cable is fed from the platform, over an end effector of the stinger, and onto the ground.

As indicated above, the cable reel also may be disposed on a trailer. The trailer may be horizontally offset from the platform, relative to a direction of gravity by an offset distance. The offset distance may be the distance between a platform central axis of the platform and a trailer central axis of the trailer. The cable is also connected to the platform via the stinger. The stinger adjusts the position of the cable, relative to the platform, according to the offset. For example, the stinger may ensure that, after leaving the end effector, the cable is disposed about along the trailer's central axis.

The method of FIG. 11 may be varied. For example, the method also may include drilling a hole in the ground using a drill connected to the platform. In this case, the stinger adjusts the position of the cable to be outside an outer radius of a chip pile disposed around the hole.

The method of FIG. 11 also may include moving the platform. Then the method also includes adjusting, while concurrently moving the platform, a position of the stinger to cause the cable to be displaced horizontally relative to the platform and relative to a direction of gravity. For example, the cable may be disposed away from the platform (e.g., along a line that is outside of an outer dimension of the platform, or along a line that is inside the outer dimension, but displaced from a central axis of the platform).

The term “about,” when used with respect to a physical property that may be measured, refers to an engineering tolerance anticipated or determined by an engineer or manufacturing technician of ordinary skill in the art. The exact quantified degree of an engineering tolerance depends on the product being produced and the technical property being measured. For example, two angles may be “about congruent” if the values of the two angles are within a first pre-determined range of angles for one embodiment, but also may be “about congruent” if the values of the two angles are within a second pre-determined range of angles for another embodiment. The ordinary artisan is capable of assessing what is an acceptable engineering tolerance for a particular product, and thus is capable of assessing how to determine the variance of measurement contemplated by the term “about.”

As used herein, the term “connected to” contemplates at least two meanings, unless stated otherwise. In a first meaning, “connected to” means that component A was, at least at some point, separate from component B, but then was later joined to component B in either a fixed or a removably attached arrangement. In a second meaning, “connected to” means that component A could have been integrally formed with component B. Thus, for example, a bottom of a pan is “connected to” a wall of the pan. The term “connected to” may be interpreted as the bottom and the wall being separate components that are snapped together, welded, or are otherwise fixedly or removably attached to each other. However, the bottom and the wall may be deemed “connected” when formed contiguously together as a monocoque body.

The figures show diagrams of embodiments that are in accordance with the disclosure. The embodiments of the figures may be combined and may include or be included within the features and embodiments described in the other figures of the application. The features and elements of the figures are, individually and as a combination, improvements to the technology of drill cable management. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an inclusive “or” and, as such includes “and.” Further, items joined by an or may include any combination of the items with any number of each item unless expressly stated otherwise.

In the above description, numerous specific details are set forth in order to provide a more thorough understanding of the one or more embodiments. However, it will be apparent to one of ordinary skill in the art that the one or more embodiments may be practiced without these specific details. In other instances, well-known features have not been described in detail to avoid unnecessarily complicating the description. Further, other embodiments not explicitly described above can be devised which do not depart from the scope of the one or more embodiments as disclosed herein. Accordingly, the scope of the one or more embodiments should be limited only by the attached claims.

What is claimed is:

1. A device comprising:
a platform;
a drill connected to the platform;
a power source for powering the drill;
a cable connected to a cable reel and to the drill; and
a stinger having a first end connected to the platform and a second end opposite the first end, wherein:
the stinger comprises a beam extending outwardly from the platform,
the second end of the stinger connects to the cable; and
the stinger is configured to guide a position of the cable, relative to the platform, as the cable moves relative to the platform and relative to the stinger.

2. The device of claim 1, wherein the stinger is configured to move, independently of movement of the platform, in a direction comprising at least one of horizontally and vertically relative to the direction of gravity.

3. The device of claim 1, further comprising:
a drum connected to the platform and to the first end of the stinger, wherein the drum is configured to move the stinger relative to the platform.

4. The device of claim 3, wherein the drum is configured to move the stinger horizontally, relative a direction of gravity, independently of movement of the platform.

5. The device of claim 1, wherein the cable reel is one of: connected to the platform and connected to a trailer separated from the platform.

6. The device of claim 1, wherein the stinger comprises a length sufficient to force the cable to move outside of an outer radius of a chip pile formed around a drill hole drilled by the drill.

7. The device of claim 1, further comprising:
a propulsion system connected to the platform and configured to move the platform as the cable reel dispenses the cable.

8. The device of claim 1, further comprising:
a trailer connected to the platform via the cable, wherein the cable reel is disposed on the trailer and wherein the trailer is horizontally offset from the platform, relative to a direction of gravity, by an offset distance; and
a drum connected to the platform and to the first end of the stinger, wherein the drum is configured to move the stinger relative to the platform; and
wherein the stinger comprises a length sufficient to guide the cable horizontally away from the platform, relative to the direction of gravity, according to the offset distance.

9. The device of claim 1, further comprising an end effector directly connected to the second end of the stinger.

10. The device of claim 9, wherein the end effector comprises one of a pulley, a second cable reel, and a cable guide.

11. The device of claim 1, further comprising:
a second end effector connected to the platform and configured to further guide the position of the cable with respect to the platform.

12. The device of claim 9, further comprising:
a trailer connected to the platform via the cable, wherein the cable reel is disposed on the trailer and wherein the trailer is horizontally offset from the platform, relative to a direction of gravity, by an offset distance; and
a second stinger connected to the trailer, wherein the second stinger is configured to further adjust the position of the cable relative to a trailer position of the trailer.

13. The device of claim 1, wherein the platform further comprises:
an anchor connected to the platform,
a crosspiece connected to the anchor,
an actuator connected to the crosspiece; and
a rotatable joint operably connected to the crosspiece and to the stinger such that actuation of the actuator extends or retracts the crosspiece, and such that extension or retraction of the crosspiece causes the beam to move relative to the anchor.

14. The device of claim 13, wherein the actuator comprises one of a solenoid actuator, a linear actuator, and a rack and pinion actuator.

15. A method comprising:
winding or unwinding a cable from a cable reel, wherein the cable is connected to a platform;
guiding the cable along a stinger that is connected to the platform; and
moving the stinger to adjust a position of the cable along the ground, wherein the position is disposed away from the platform.

16. The method of claim 15, wherein:
the cable reel is disposed on the platform; and
the stinger adjusts the position of the cable as the cable is fed from the platform, over an end effect of the stinger, and onto the ground.

17. The method of claim 15, wherein:
the cable reel is disposed on a trailer,
the trailer is horizontally offset from the platform, relative to a direction of gravity by an offset distance,
the cable is further connected to the platform; and
the stinger adjusts the position of the cable, relative to the platform, according to the offset.

18. The method of claim 15, further comprising:
drilling a hole in the ground using a drill connected to the platform;
wherein the stinger adjusts the position of the cable to be outside an outer radius of a chip pile disposed around the hole.

19. The method of claim 15, further comprising:
moving the platform; and
adjusting, concurrently with moving the platform, a stinger position of the stinger to cause the cable to be displaced horizontally relative to the platform and relative to a direction of gravity.

20. A device comprising:
a platform;
a drill connected to the platform;
a power source for powering the drill;
a cable connected to a cable reel and to the drill;
a stinger having a first end connected to the platform and a second end opposite the first end, wherein:
the stinger comprises a beam extending outwardly from the platform,
the second end of the stinger connects to the cable,
the stinger is configured to guide a position of the cable, relative to the platform, as the cable moves relative to the platform and relative to the stinger,
the stinger comprises a length sufficient to force the cable to move outside of an outer radius of a chip pile formed around a drill hole drilled by the drill, and
the stinger further comprises an end effector directly connected to the second end of the stinger, wherein the end effector is configured to permit the cable to slide with respect to the end effector as the stinger pushes the cable,
a drum connected to the platform and to the first end of the stinger, wherein the drum is configured to move the stinger relative to the platform;
an actuator disposed within the drum and configured to move stinger; and
a propulsion system connected to the platform and configured to move the platform as the cable reel dispenses the cable.
